(19) United States
(12) Patent Application Publication
(10) Pub. No.: US 2009/0145349 A1
(43) Pub. Date: Jun. 11, 2009

(54) Fluid Flow Indicator

(76) Inventor: William C. Hebert, Reno, NV (US)

Correspondence Address: PATWRITE LLC, 408 W. MAIN ST., MARSHALLTOWN, IA, 50158-5759, US

(21) Appl. No.: 12/330,341

(22) Filed: Dec. 8, 2008

Related U.S. Application Data
(60) Provisional application No. 61/012,062, filed on Dec. 7, 2007.

(51) Int. Cl. G01F 15/00

(52) U.S. Cl. 116/264

(57) ABSTRACT

A fluid flow indicator consists of a flow chamber having a freely spinning flow rate indictor that rotates in response to fluid flow and rotates in proportion to the rate of flow. A visible indicator allows a medical practitioner to carefully control the flow rate even though the fluid flow is smooth without other visible signs of movement. In one embodiment a plurality of flow holes are provided in the fluid chamber to direct the fluid around the fluid flow indicator rotor causing the rotor to rotate in proportion to the rate of fluid flow. Another embodiment provides a flow opening to direct the fluid past the rotor. The fluid chamber is provided with a connecting nipple on either end to connect the flow indicator with a fluid delivery system.

### BACKGROUND OF THE INVENTION

As medical advances continue, the need to administer fluids to patients is increasingly important. Fluid therapy has been a medical practice since at least the 15^{th} century. Today, chemotherapies have widespread use in cancer treatments and are often delivered by a fluid flow system. Other drugs and fluid replacements therapies are extremely important and have a major role in modern medicine.

One highly successful method of IV fluid therapy involves a “drip method” whereby a precise amount of fluid is introduced to the patient by passing through an IV drip chamber allowing the medical practitioner to visually observe the rate at which the fluid is being administered. Some medication and other therapies require much faster flow rates than are attainable using a drip IV method. There is a need for an IV apparatus and method for accurately observing the flow rate of fluid therapies requiring a fast flow rate.

### SUMMARY OF THE INVENTION

A fluid flow indicator consists of a flow chamber having a freely spinning flow rate indictor that rotates in response to fluid flow and rotates in proportion to the rate of flow. A visible indicator allows a medical practitioner to carefully control the flow rate even though the fluid flow is smooth without other visible signs of movement. In one embodiment a plurality of flow holes are provided in the fluid chamber to direct the fluid around the fluid flow indicator rotor causing the rotor to rotate in proportion to the rate of fluid flow. Another embodiment provides a flow opening to direct the fluid past the rotor. The fluid chamber is provided with a connecting nipple on either end to connect the flow indicator with a fluid delivery system.

Other features and advantages of the instant invention will become apparent from the following description of the invention which refers to the accompanying drawings.

### BRIEF DESCRIPTION OF THE DRAWINGS

FIG. 1 is a side view of an IV fluid flow indicator according to an embodiment of the present invention.

FIG. 2 is a cut-away view of an IV fluid flow indicator according to an embodiment of the present invention.

FIG. 3 is a perspective view of an IV fluid flow indicator according to an embodiment of the present invention.

FIG. 4 is a detail view of the portion shown in FIG. 3.

FIG. 5 is a perspective view of an IV fluid flow indicator according to an embodiment of the present invention.

FIG. 6 is a detail view of the portion shown in FIG. 5.

FIG. 7 is a perspective view of an IV fluid flow indicator according to an embodiment of the present invention.

FIG. 8 is a detail view of the portion shown in FIG. 7.

FIG. 9 is a side view of an IV fluid flow indicator according to an embodiment of the present invention.

FIG. 10 is a side view of an IV fluid flow indicator according to an embodiment of the present invention.

FIG. 11 is side view of an IV fluid system with an IV fluid flow indicator according to the present invention.

FIG. 12 is a cross sectional view of the fluid flow chamber shown in FIG. 7.

FIG. 13 is a cross sectional view of the fluid flow chamber shown in FIG. 5.

FIG. 14 is a side view of an IV fluid flow indicator according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

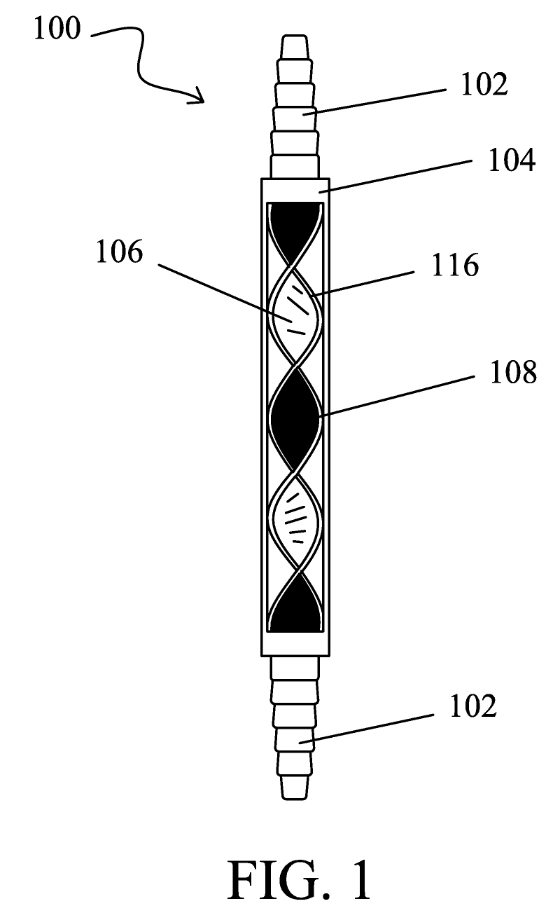

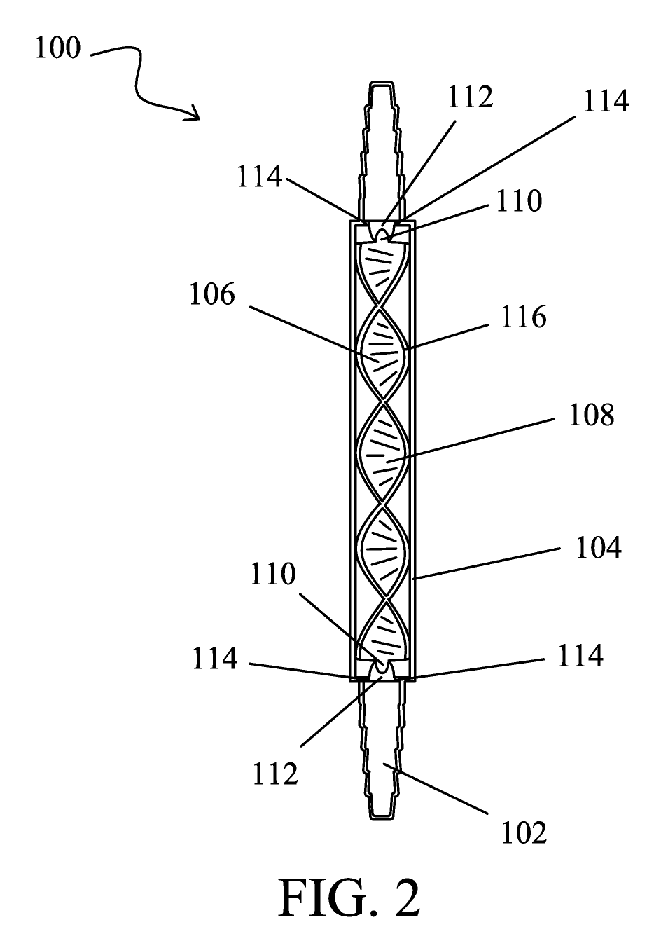

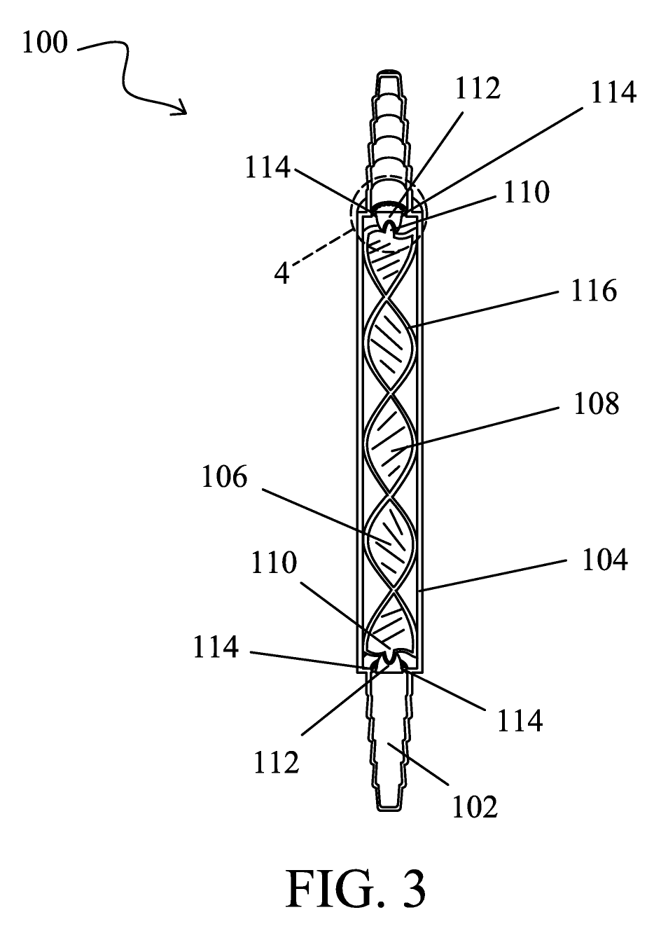

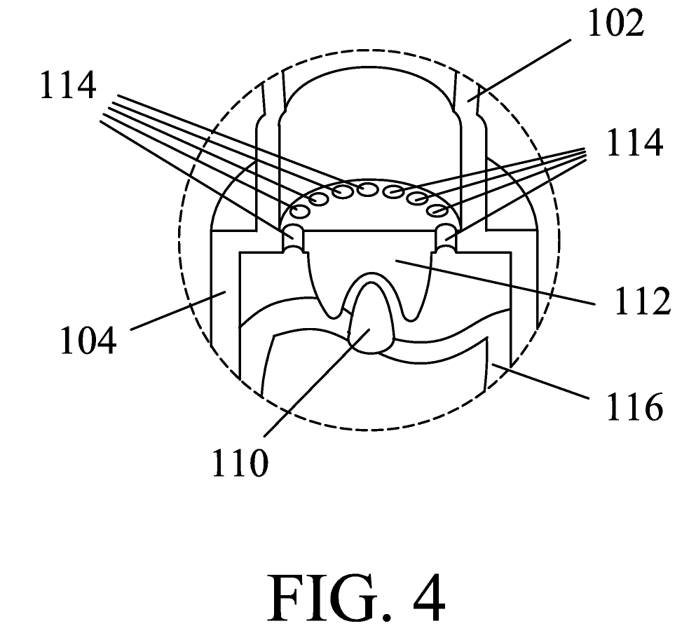

Referring to FIGS. 1 through 4 and 11, an IV fluid flow apparatus 100 is shown having an upper and lower nipple connector 102 to connect flow apparatus 100 to IV source 804. A flow indicator rotor 116 is rotatably mounted within a flow chamber 104. Flow chamber 104 may be made of a clear material such as glass or plastic. Alternatively, flow chamber 104 could have a frame cutout holding see through portions. Rotor 116 has a first side 106 and a second side 108 that are visually unique to aid in observing rotation. A bearing holder 112 rotatably holds rotor bearing 110 allowing rotor 116 to rotate in response to fluid (not shown) passing through fluid chamber 104. A plurality of fluid flow holes 114 are provided to direct the fluid (not shown) to fluid chamber 104. Rotor 116 responds to torque produced as the fluid (not shown) impinges on the vanes of rotor 116. Fluid flow holes may be of varying diameters depending on the fluid viscosity or other properties as needed. Additionally, the number of holes is also matched to specific applications.

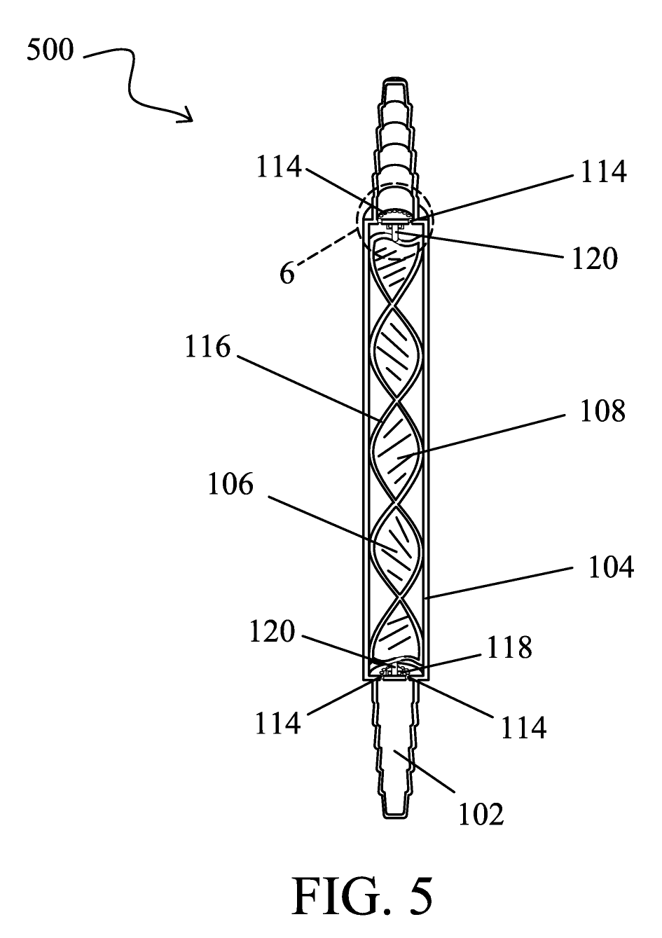

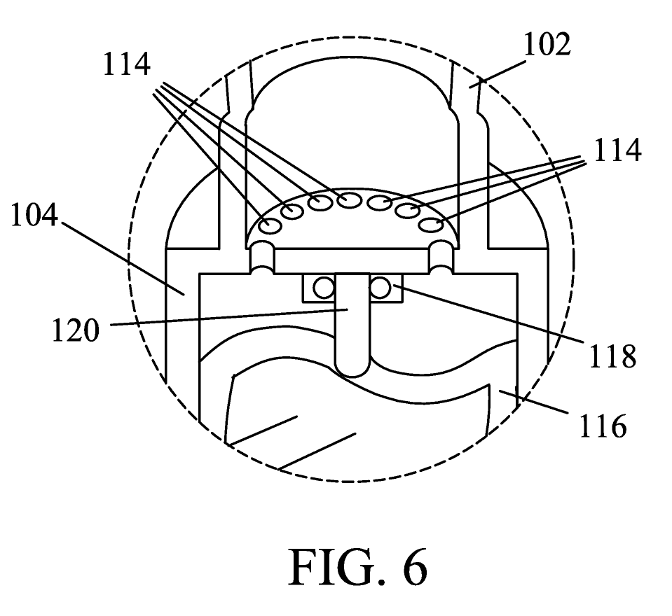

Referring now to FIGS. 5 and 6, an IV flow apparatus 500 is shown having an upper and lower ball bearing 118 designed to rotatably engage a rotor axle 120 allowing rotor 116 to rotate with minimal frictional resistance in response to the torque produced as the fluid (not shown) impinges on the vanes of rotor 116.

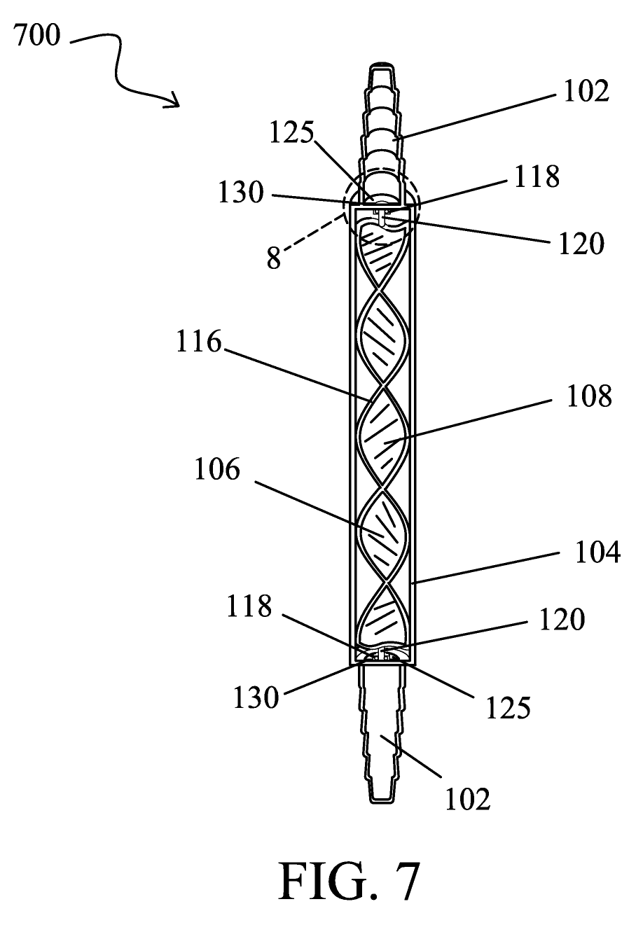

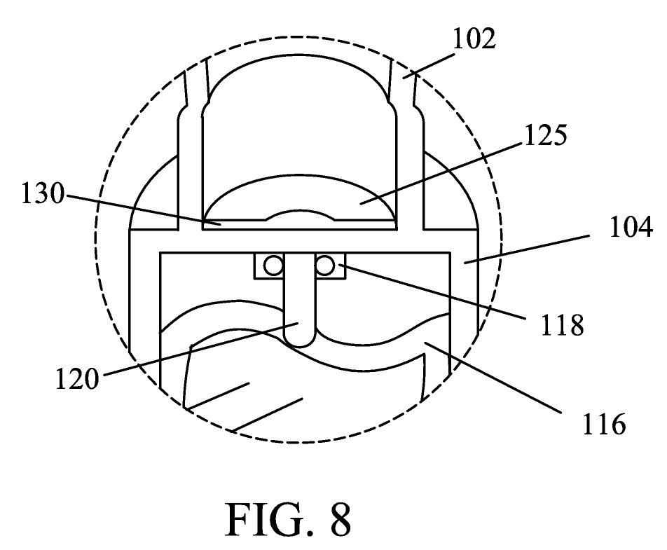

Now referring to FIG. 7 and 8, an IV flow apparatus 700 is shown having fluid flow openings 125 to minimize fluid flow resistance and damage to fluid structure. A bearing support structure 130 is used to securely hold ball bearing 118 allowing rotor axle 120 to spin in response to fluid flow.

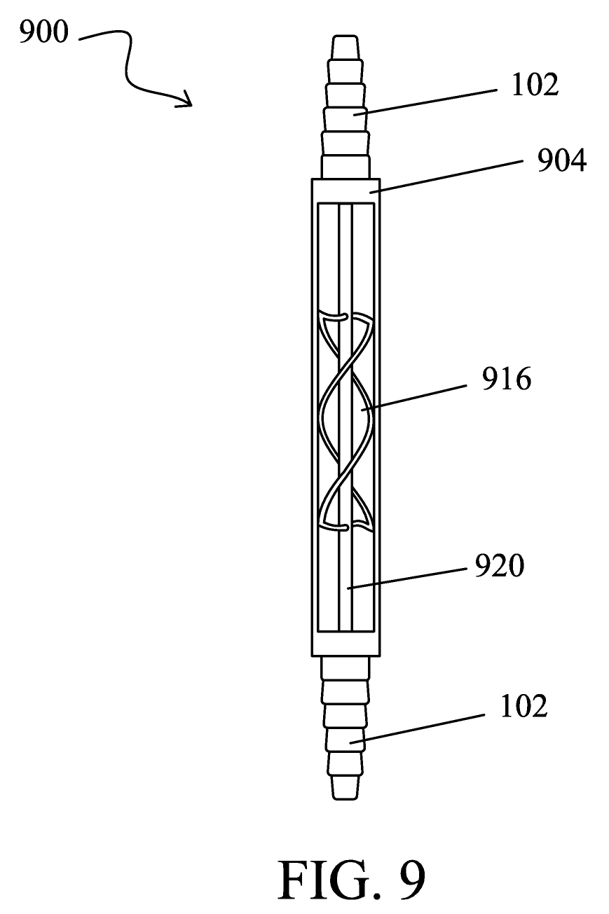

Referring now to FIG. 9, an IV fluid apparatus 900 is shown having a rotor 916 which is a ribbon like structure designed to revolve around a rotor axle 920 in response to torque produced as the fluid (not shown) impinges on the vanes of rotor 916.

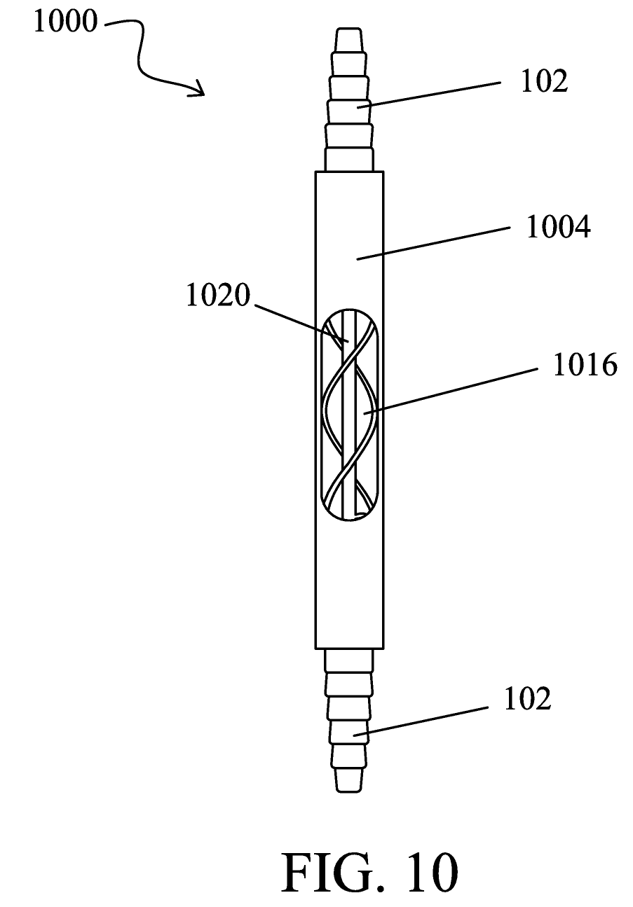

FIG. 10 shows an IV fluid apparatus 1000 having an opaque or translucent fluid flow chamber 1004 with a view opening 1050 to allow the medical practitioner to see the rotation of a rotor 1016 as it rotates around a rotor axle 1020. View opening 1050 is a cutout holding a transparent insert portion made of plastic, glass or other appropriate transparent material. The insert must be glued or sealed to prevent fluid leakage as is known in the art.

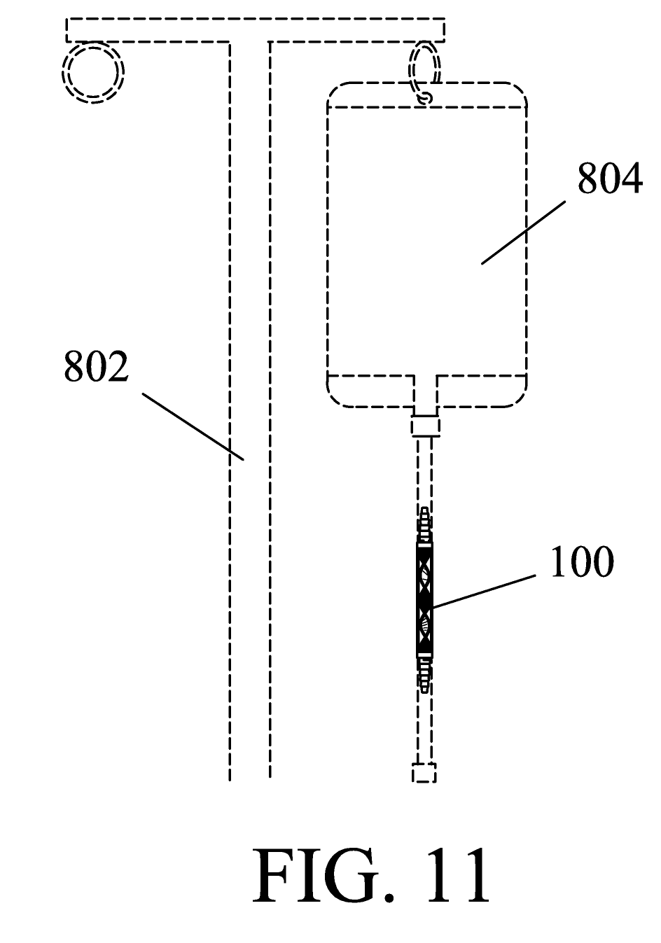

FIG. 11 illustrates IV fluid apparatus 100 connected to a typical IV source 804 and holder 802. Of course other IV setups are known and IV flow indicator according to the present invention can be connected to any fluid delivery method that connects through the use of tubing.

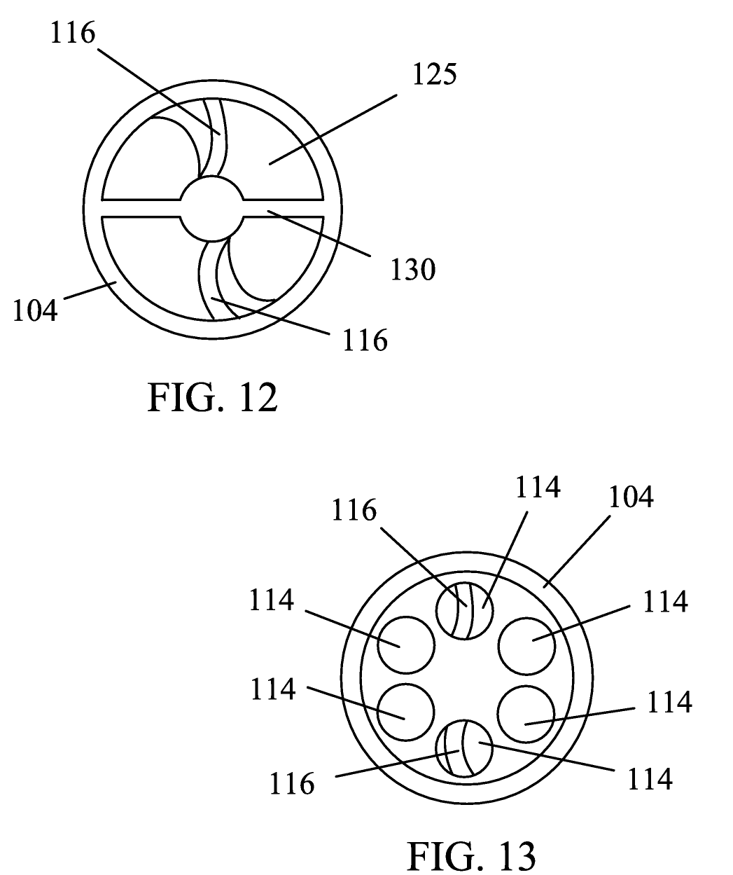

With reference to FIG. 12 and 13, a cross sectional top view is shown to further clarify the arraignment of flow opening 125 having bearing support structure 130 that holds the rotor bearing in place. FIG. 13 shows an alternative orientation of the plurality of fluid flow holes 114 designed to direct the fluid through fluid flow chamber 104.

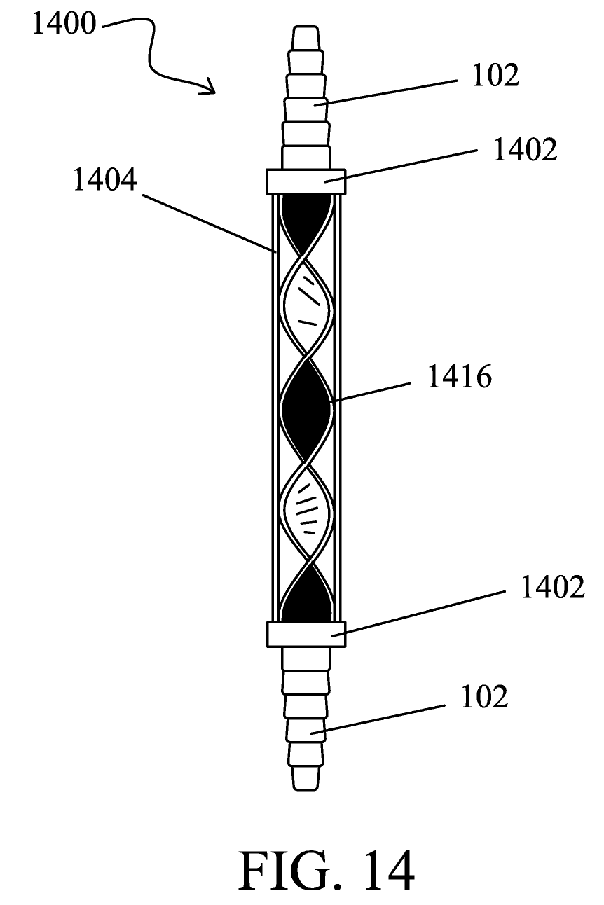

Referring now to FIG. 14, an IV flow indicator 1400 is shown having an upper and lower fluid chamber cap 1402 fitting over a transparent flow chamber 1404. Flow chamber 1404 encloses a rotor 1416. This embodiment may have a bearing structure such as shown in FIG. 1 or 5 or it may simply use a close fitting rotor 1416 that is free to rotate within flow chamber 1404 without the need for any other bearing structure.

Although the instant invention has been described in relation to particular embodiments thereof, many other variations and modifications and other uses will become apparent to those skilled in the art.

What is claimed is:

1. A flow indicator comprises
a fluid flow chamber having a at least one viewing portion disposed therein;
a flow indicator rotor rotatably disposed within said flow chamber wherein said flow indicator rotor rotates at a speed proportional to a fluid flow delivery speed; and
a connecting means for connecting said flow indicator to a fluid delivery system tubing for connected to each end of said flow chamber.

2. The flow indicator of claim 1 wherein said flow indicator rotor has at least two visually unique sides wherein rotational speed is more easily determined when said flow indicator rotor is spinning.

3. The flow indicator of claim 1 wherein said fluid flow chamber has a first end and a second end opposedly disposed therein.

4. The flow indicator of claim 3 wherein said connecting means comprises a nipple connected to said first end and another nipple connected to said second end.

5. The flow indicator of claim 1 further comprising a bearing means adapted to allow said flow indicator rotor to rotate.

6. The flow indicator of claim 5 wherein said bearing means is a bushing bearing.

7. The flow indicator of claim 5 wherein said bearing means is a ball bearing.

8. The flow indicator of claim 1 further comprising;
a first flow indicator rotor retainer disposed along a first end portion within said fluid flow chamber;
a second fluid flow indicator retainer disposed along a second portion wherein said flow indicator rotor is rotatably held therein.

9. The flow indicator of claim 8 wherein said first and second flow indicator retainer having at least one fluid flow opening therein wherein a fluid passes through said at least one fluid flow opening.

10. The flow indicator of claim 1 wherein said fluid flow indicator comprises a helically wound rotating surface disposed on a central rotating axle.
